(19) United States
(12) Patent Application Publication
(10) Pub. No.: US 2003/0068946 A1
(43) Pub. Date: Apr. 10, 2003

(54) Toilet tissue article

(76) Inventor: Yury Nemiro, Mogilev (BY)

Correspondence Address: IIya Zborovsky, 6 Schoolhouse Way, Dix Hills, NY, 11746, US

(21) Appl. No.: 09/972,501

(22) Filed: Oct. 9, 2001

(51) Int. Cl. B32B 9/04; D04H 1/00

(52) U.S. Cl. 442/153

(57) ABSTRACT

A toilet tissue article has a toilet tissue element, and an image of an individual so that using of the toilet tissue article for wiping a corresponding part of the body, a wiping involves application of the image of the individual onto the part of the user's body, thus expressing his negative attitude toward the individual whose image is presented on the toilet tissue element.

### BACKGROUND OF THE INVENTION

The present invention relates generally to toilet tissue articles.

Toilet tissue articles are well known and widely utilized. Some toilet tissue articles are provided with various patterns, images, etc. It is believed that the existing toilet tissue articles can be further improved.

### SUMMARY OF THE INVENTION

Accordingly, it is an object of the present invention to provide a toilet tissue article which is a further improvement of the existing articles of this type.

In keeping with these objects and with others which will become apparent hereinafter, one feature of present invention resides, briefly stated, in a toilet tissue article which has a toilet tissue element; and means provided on the toilet tissue element and identifying an image of at least one individual, so that during the use of the toilet tissue article for wiping corresponding body parts, a user by applying the toilet tissue element with the image expresses his negative attitude to the individual whose image is provided on the toilet tissue element.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a toilet tissue article in accordance with the present invention in a non-use condition;

FIG. 2 is a view showing a portion of the toilet tissue element in accordance with one embodiment of the present invention, in an unfolded position;

FIG. 3 is a view showing a portion of the toilet tissue element in accordance with another embodiment of the present invention in an unfolded position; and

FIG. 4 is a view showing a portion of the toilet tissue element in accordance with a further embodiment of the present invention in an unfolded position.

### DESCRIPTION OF THE PREFERRED EMBODIMENTS

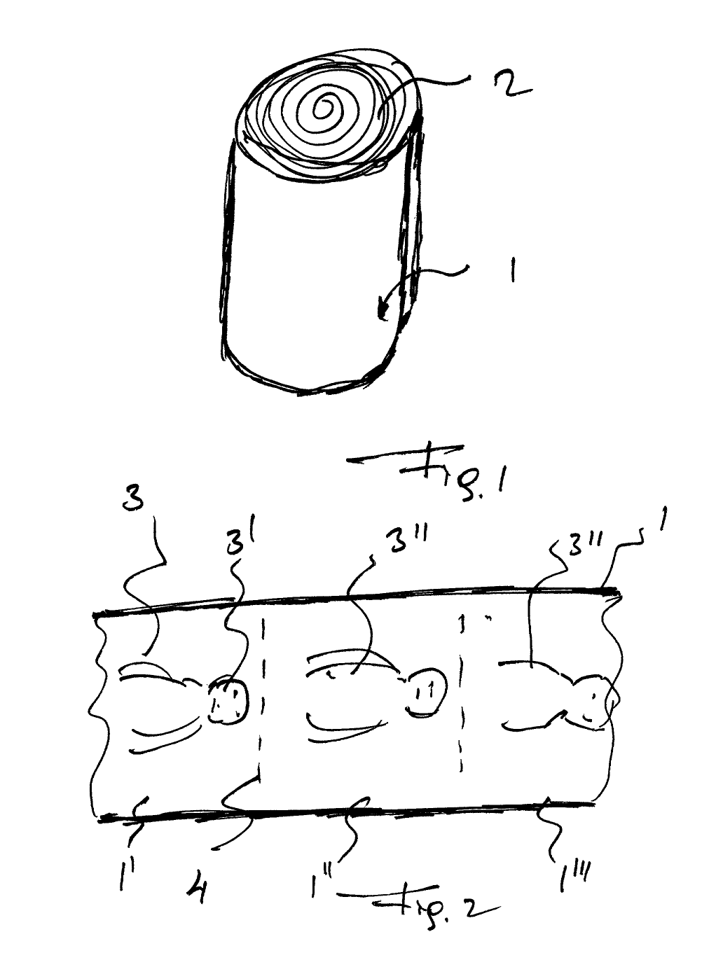

A toilet tissue article in accordance with the present invention has a toilet tissue element which is identified as a whole with reference numeral 1. Conventionally, the toilet tissue element is composed of a toilet tissue paper which is suitable for using as a toilet tissue, or in other words has corresponding softness, absorbing properties, etc. The toilet tissue element can be wound into a roll 2 and the like, as shown in FIG. 1.

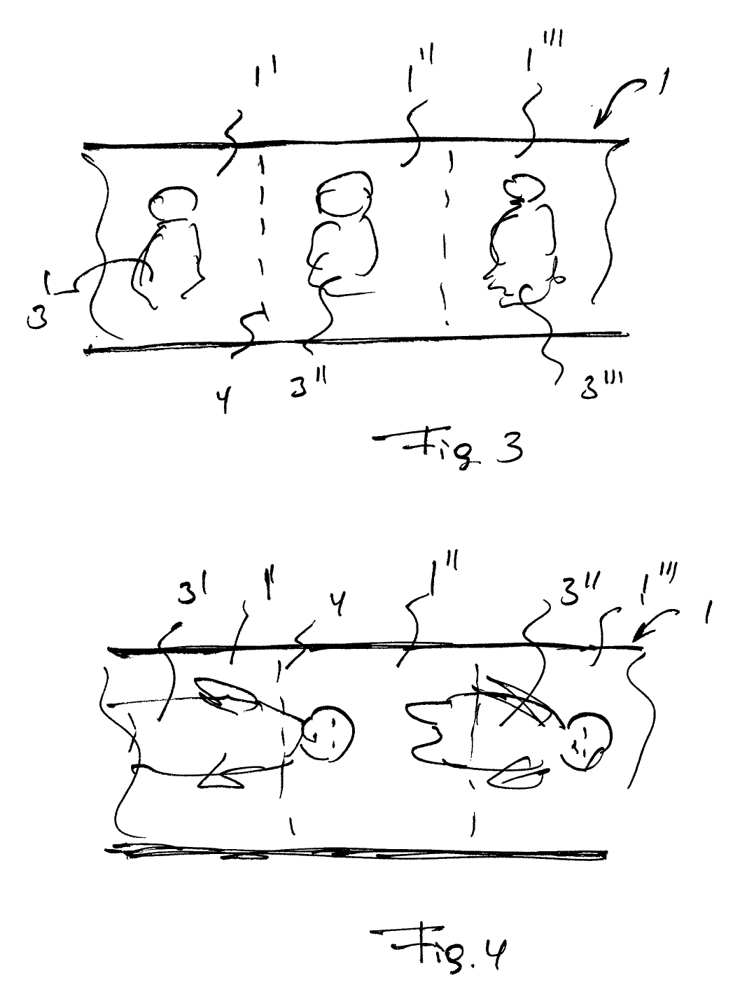

FIG. 2 shows a portion of the toilet tissue article in accordance with the present invention in an unwound or unrolled condition. The toilet tissue element 1 is unrolled to form a long band which will be subsequently rolled into a roll 1. On the band, means for representing an image of an individual is provided and identified with reference numeral 3. As shown in FIG. 3, the image forming means have a plurality of individual images 3′, 3″ 3′″. The toilet tissue element 1, on the other hand can be subdivided into a plurality of portions 1′, 1″, 1′″. These portions, as well known in the art, separated from one another by for example perforations 4.

In accordance with the embodiment shown in FIG. 2, each individual image 3′, 3″, 3′″ is provided in the corresponding separate portions 1′, 1″, 1′″ of the toilet tissue element 1. When a person tears off one portion, or two portions or more, he always tears off such a part of the toilet tissue element 1 which contains one image or two images, or three images, and in any case an integral number of the fully represented images.

In the embodiment of FIG. 2 the images are also arranged so that they extend in direction of elongation of the toilet tissue element 1. In other words, the upper torso of the individual which represents the image is arranged so that the height of the individual whose image is represented extends along the direction of elongation of the toilet tissue element 1.

FIG. 3 shows another embodiment of the present invention. Here also the toilet tissue element 1 is subdivided into a plurality of portions 1′, 1″, 1′″. Here however, each individual image 3′, 3″, 3′″ is arranged transversely to the direction of elongation of the toilet tissue element 1. In other words, the height of the individual whose image provided on the toilet tissue element 1 extends transversely to the direction of elongation, or in a transverse direction of the toilet tissue element 1.

FIG. 4 shows still a further embodiment of the present invention. Here the images on the toilet tissue element 1 are arranged so that they extend over an area which exceeds the size of the portions of the toilet tissue element 1 between the perforations. In other words, as can be clearly seen from FIG. 4, a single image of the person provided on the toilet tissue element 1 extends through one full portion between two perforations and into the other neighboring portion of the toilet tissue element 1. Therefore, when portion of the toilet tissue element 1 is separated from other portions, the image is not separated fully, but instead is cut through.

The image forming means can be formed for example by corresponding printing technique with an ink and the like. However, in a preferred embodiment the images on the toilet tissue element are formed by displacing corresponding areas along a contour of the corresponding image, without application of any additional substance, such as an ink or the like. This process includes forming an image for example by pressing the material with a tool having a contour corresponding to the contour of the required image so as to provide the depressed or displaced contour. Also, this can be done by forming a plurality of perforations along the contour of the image, etc.

It will be understood that each of the elements described above, or two or more together, may also find a useful application in other types of constructions differing from the types described above.

While the invention has been illustrated and described as embodied in toilet tissue article, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A toilet tissue article, comprising a toilet tissue element; and means for providing on said toilet tissue element an image of an individual so that using of the toilet tissue article for wiping a corresponding part of the body, a wiping involves application of the image of the individual onto the part of the user's body, thus expressing his negative attitude toward the individual whose image is presented on said toilet tissue element.

2. A toilet tissue article as defined in claim 1, wherein said image is composed of a plurality of images of the individual which are spaced from one another in a direction of elongation of said toilet tissue element.

3. A toilet tissue article as defined in claim 1, wherein said image of the individual extends in a direction of elongation of said toilet tissue element.

4. A toilet tissue article as defined in claim 1, wherein said image of the individual extends in a direction which is transverse to the direction of elongation of said toilet tissue element.

5. A toilet tissue article as defined in claim 1, wherein said toilet tissue element is subdivided in a plurality of portions, said image including a plurality of images of the individual arranged so that each of the images is located in a corresponding one of said portions.

6. A toilet tissue article as defined in claim 1, wherein said toilet tissue element is subdivided into a plurality of portions, said image being composed of a plurality of images arranged so that at least some of the images extend over more than one of said portions.

7. A toilet tissue article as defined in claim 1, wherein said means for forming an image is formed as a displaced area of said toilet tissue element.
